(19) United States
(12) Patent Application Publication
(10) Pub. No.: US 2024/0059532 A1
(43) Pub. Date: Feb. 22, 2024

(54) Arrangement with a good having an opening and with a lifting end piece and related lifting end piece

(71) Applicants: J.D. Theile GmbH & Co. KG, Schwerte (DE); ABI Anlagentechnik-Baumaschinen-Industriebedarf Maschinenfabrik und Vertriebsgesellschaft mbH, Niedernberg (DE)

(72) Inventors: Martin Foitzik, Schwerte (DE); Isabella Neubert, Niedernberg (DE); Manuel Meinel, Niedernberg (DE); Christian Heichel, Niedernberg (DE)

(21) Appl. No.: 18/450,090

(22) Filed: Aug. 15, 2023

(30) Foreign Application Priority Data
Aug. 22, 2022 (EP) 22191379.1

(51) Int. Cl. B66C 1/66

(52) U.S. Cl. CPC B66C 1/66

(57) ABSTRACT

An arrangement including an object with an opening and a lifting end piece for connecting a lifting means to the object. The lifting end piece has a pin, which extends through the opening, with an attachment point for connecting the lifting means. The lifting end piece also has a shield connected to the pin and aligned transversely to the orientation of the pin. The base of the shield is configured to be larger than the opening of the object such that, when the pin is inserted through the opening of the object and the lifting end piece is lifted at its attachment point, the shield is supported on the material of the object surrounding the opening and in this way the object is raised. The support surface of the shield, which faces in the direction of the pin, is designed to taper starting from the pin towards its edge.

### RELATED APPLICATION

This application claims priority to European application EP 22191379.1 filed Aug. 22, 2022, which is incorporated-by-reference herein for all purposes.

### BACKGROUND

The disclosure relates to an arrangement with an object having an opening and a lifting end piece for connecting a lifting means to the object. As used herein, objects to be lifted include all types of objects that have a loadable opening via which the object can be lifted. Such an object can be a plate-shaped object, such as a sheet pile wall, for example. The loadable opening in the object can be introduced into the object at the factory or on site, for example at a construction site. Such an opening is usually arranged offset from the center of the object to be lifted, usually near the edge. If such an object lies flat on the ground, it is sometimes the aim to lift the edge of the object in such a way that the object is aligned essentially vertically when it is completely lifted.

According to one approach for lifting an object, a lifting means, such as a chain or a lifting belt, is guided through the opening in the object. Both ends of the lifting means are then attached to a lifting device, such as a crane or ram. The lifting means thus forms a U-shape, the free ends of which are connected to the lifting device.

According to another approach for lifting an object, the lifting means is provided at one end with a crossbar, the diameter of which is smaller than the opening in the object to be lifted, but the length of which is greater than the cross section of the opening in the object to be lifted. The lifting connection is designed in the manner of a toggle closure, with the cross bar connected to the lifting means in an articulated manner. To connect the lifting means to the object to be lifted, the cross bar is aligned essentially parallel to the lifting means and passed completely through the opening. After the cross bar is passed through the opening, the cross bar is then aligned transversely to the lifting means and thus abuts against the material of the object surrounding the opening when the lifting means is raised by the lifting device.

The German designs DE 402017100332-0001 and DE 402017100332-0002 disclose a lifting end piece with a pin and a plate-shaped shield formed on the pin. An end of the pin has an attachment point for connecting the lifting means. The planar extension of the shield is transverse to the alignment of the pin and larger than the opening of the object. To lift the object, the lifting means connected to the pin and the pin itself are guided through the opening in the object and the lifting means is attached to the lifting device. When the lifting means is raised by the lifting device, the material of the object surrounding the opening is supported on the shield of the lifting end piece and the object is lifted in this way. If the object is equipped with the opening at its edge, the pin of the lifting end piece is usually aligned substantially horizontally in the lifted state and the face of the opening rests on the pin. In order to ensure alignment of the lifting end piece in a certain direction, the pin is curved so that the attachment point is not aligned with the opening of the object.

One problem with this design is that the production of such a lifting end piece is not only complex and expensive, but also entails the risk that the lifting end piece will jam at its curvature of the pin in the opening and there is a risk that an unfavorable load situation is created, which causes the connection between the object to be lifted and the lifting means to break.

The foregoing examples of the related art and limitations therewith are intended to be illustrative and not exclusive. Other limitations will become apparent to those skilled in the art upon a reading of the specification and a study of the drawings.

### SUMMARY

The following embodiments and aspects thereof are described and depicted in conjunction with systems, tools and methods which are meant to be illustrative, not limiting in scope. In various embodiments, one or more problems have been reduced or eliminated, while other embodiments are directed to other improvements.

Proceeding from this background, one aspect of the disclosure is to improve a lifting end piece so that it is not only cheaper to produce but also more secure. This is provided by a lifting end piece comprising: a pin having an attachment point on a free end thereof for connecting the lifting means; and a shield formed on another end of the pin opposite the attachment point, the shield aligned transversely to a longitudinal extension of the pin and projecting outward from the pin; wherein a base of the shield is configured to be larger than the opening in the object such that, when the pin is inserted through the opening of the object and the lifting end piece is lifted at the attachment point, the shield is supported on material of the object surrounding the opening; and wherein a support surface of the shield, which faces in a direction of the pin, tapers starting from the pin toward an edge of the shield.

Another aspect relates to an arrangement including such an object having an opening and such a lifting end piece for connecting a lifting means to the object. The arrangement comprises: the lifting end piece; the lifting means connected to the attachment point of the lifting end piece; and the object with the pin of the lifting end piece inserted through the opening of the object; wherein the shield of the lifting end piece is arranged on an opposite side of the opening of the object from the attachment point and the lifting means; and wherein the shield of the lifting end piece is larger than the opening of the object, such that the shield is prevented from passing therethrough in any position relative to the opening.

The shield of the lifting end piece has an angled support surface. The taper is usually along an axis of the base of the shield, but can also be multi-axial, although for ease of manufacture, the taper along only one axis, extending from the pin to the edge of the shield, is preferred. The geometry of the shield is only of secondary relevance in this case; round as well as angular geometries can be provided.

The taper may be configured such that it is 6° to 10° relative to a virtual surface that is orthogonal to the longitudinal axis of the pin. Such a taper is already sufficient for a variety of design variants in order to obtain corresponding advantages.

A tilting of the lifting end piece is thus ensured with a contact surface of the shield against the object to be lifted, which is not orthogonal to the longitudinal extension direction of the pin, when the object is lifted and the pin for holding the object in the raised position is aligned essentially horizontally. This relieves the transition between the pin and shield.

In addition, due to the larger angle between the outer surface of the pin and the contact surface of the shield, the notch effect between the shield and the pin is reduced and the flow of forces between the shield and the pin is more advantageous.

The pin may be straight in its longitudinal extension. In such embodiments, the fact that the pin is not curved allows the force to flow freely from the shield to the attachment point, which is usually located at a distal end of the pin. A possible deflection of the force then does not take place within the material, but within a joint provided by the connection of the lifting end piece to the lifting means. This is particularly important with transverse loading of the lifting end piece, particularly in case of percussive transverse loading. In addition, the orientation of the shield in the opening has no influence or plays only a minor role in terms of the load on the pin.

The lifting end piece may also be designed as a forged part. Not only does this bring cost advantages, but particularly advantageous mechanical properties can also be achieved by precisely aligning the fibers within the lifting end piece. The lifting end piece can be forged in such a way that the fibers within the workpiece run from the pin into the shield, which corresponds to the flow of forces and therefore results in greater strength.

In some embodiments, the shield has a base with semi-axes, which are at right angles to one another, of different lengths. The major axis (the longer semi-axis) may be about 50% longer than the minor axis (the shorter semi-axis). This configuration provides a shield that can handle openings in the object which are larger than intended. At the same time, the weight of the lifting end piece is not unnecessarily increased for this special case. The axes of unequal length also enable intuitive alignment. For example, the base area may be designed with an oval form. An oval base is ergonomic to hold in the hand.

In some embodiments, the shield tapers more sharply in the direction of the minor axis than in the direction of the major axis, wherein it may also be provided that no taper is present in the direction of the major axis. The shield thus has a greater thickness at the distal ends of the major axis than at the distal ends of the minor axis. In this way, the lifting end piece can align itself automatically during the lifting process, or an automatic alignment is thereby facilitated. The lifting end piece will usually align with the objects to be lifted in such a way that there is the greatest possible distance between the opening and the lifting means. Due to the defined distance between the shield and the attachment point—the length of the pin—this means that the pin is aligned as vertically as possible. An angle of more than 90° between the direction of longitudinal extension of the pin and the side of the shield facing in a direction of the pin—the support surface for the object—allows the pin to be aligned more vertically in a horizontal arrangement than is the case in certain prior art. Due to the different degrees of tapering with respect to the main and minor axes, the lifting end piece will automatically rotate in the opening of the object and align itself accordingly if it is not already in this preferred tilting orientation. This effect is intensified by greater tapering.

In some embodiments, the shield has its greatest thickness along its major axis. In this way, the shield is particularly supported in the direction of its greatest extent in order to safely introduce any forces acting on the outer edge into the pin and the attachment point. The moment of resistance to bending is particularly large in this way.

In some embodiments, the attachment point of the pin is provided in the form of an eye, with the penetration direction of the eye through the pin aligned in parallel to the minor axis. Where the shield is also tapered in the direction of the minor axis, a lifting end piece is obtained with which objects can be lifted particularly safely:

If the lifting piece is positioned such that the eye is aligned with its cross-sectional area in a vertical orientation, when lifting the object, the point of engagement of the lifting means is approximately at the top of the eye. A change in the point of engagement starting from this position would lead to a reduction in the distance between the opening and the lifting means in the vertical direction, which characterizes this arrangement as a stable position.

If the lifting piece is positioned such that the eye is aligned with its cross-sectional area in a horizontal orientation, when lifting the object, the point of engagement of the lifting means is in the downward-pointing region of the pin forming the edge of the eye. In the following, it is first assumed that the shield is not tapered. If the point of engagement is approximately in the lateral region of the edge and therefore off-center from the longitudinal axis of the pin, when the object is lifted, the lifting end piece will align itself due to the off-center engagement, which induces a lever arm, in such a way that the eye is aligned with its cross-sectional area in a vertical orientation. Only an exactly centered engagement would not cause such self-alignment, for example if the point of engagement is at the distal end of the pin. However, a small change in the point of engagement will cause the lifting end piece to rotate due to the aforementioned effect, making this position an unstable position. A small local change in the point of engagement is also probable. If the lifting end piece turns from an initially unstable orientation to a stable one, this can lead to a sudden and unforeseen or undesirable lowering of the object to be lifted.

This is counteracted by the taper angle of the shield in that the immanent change in distance in the vertical direction between the opening and lifting means, due to the rotation of the eye from a horizontal to a vertical orientation, is eliminated as a result of the possibility of tilting of the pin relative to the object to be lifted by a suitable selection of the taper angle, the length of the pin, and the strength of the material surrounding the eye of the pin. The tapering of the shield in the direction of the penetration direction of the eye allows the pin to be tilted only slightly when the eye is aligned in the unstable position, while tilting in the stable position rotated 90° relative thereto is not possible or at least less possible. In order to change the point of engagement in the actually unstable position, the distance between the opening and the lifting means would have to be reduced in the vertical direction, which is not possible due to the lifting load. The possible difference in the height distances between the point of engagement and the opening as a result of the different orientations of the eye is thus eliminated.

In some embodiments, the back side of the shield facing away from the pin is also tapered, starting from its center towards its edge. The taper may be a mirror image of the taper on the side of the shield facing the pin. The described effects due to tapering are thereby further intensified. For example, the weight of the lifting end piece is further reduced. The manufacturability of such a lifting end piece is also simplified, in particular by using a forging process.

Preferably, the diameter of the pin increases continuously from the attachment point towards the shield along the longitudinal extent of the pin. In this way, the pin is already inherently formed on the shield with an angle of more than 90° (without considering the additional tapering of the shield), so that large radii with a small notch effect are possible. This also simplifies the insertion of the pin into the opening.

In some embodiments, the diameter of the pin increases to a lesser extent along its longitudinal extension in the direction of an axis of the shield than in the direction transverse to the axis. If the shield is oval in shape, the diameter of the pin along its longitudinal extension, starting from the attachment point, preferably increases less in the direction of the major axis of the shield than in the direction of the minor axis of the shield.

Usually, the pin does not have a square cross-section in the region of the attachment point, and the pin is smaller in thickness than in width. In this way, an attachment geometry is provided similar to that of a chain link, which saves space and weight. At the same time, the attachment point can be fully integrated in the pin in the form of an eye, so that notches or the like do not need to be provided on the outside.

In addition to aspects and embodiments described above, further aspects and embodiments will become apparent by reference to the appended drawings, wherein like reference numerals generally designate corresponding structures in the several views.

### BRIEF DESCRIPTION OF THE DRAWINGS

The disclosure is explained below with reference to the drawings, wherein:

FIGS. 1a and 1b show front perspective views of an example lifting end piece in two different orientations,

FIG. 2 shows a rear perspective view of the lifting end piece of FIG. 1a,

FIG. 3 shows a front perspective view of an arrangement with the lifting end piece inserted through the opening of an object and connected to lifting means,

FIG. 4 shows a rear perspective view of the arrangement of FIG. 3, and

FIG. 5 shows a side view of the arrangement of FIG. 3.

Before explaining example embodiments, it is to be understood that the invention is not limited in application to the details of particular arrangements shown in the drawings, since the invention is capable of other embodiments. Embodiments and figures disclosed herein are to be considered illustrative rather than limiting.

### DETAILED DESCRIPTION

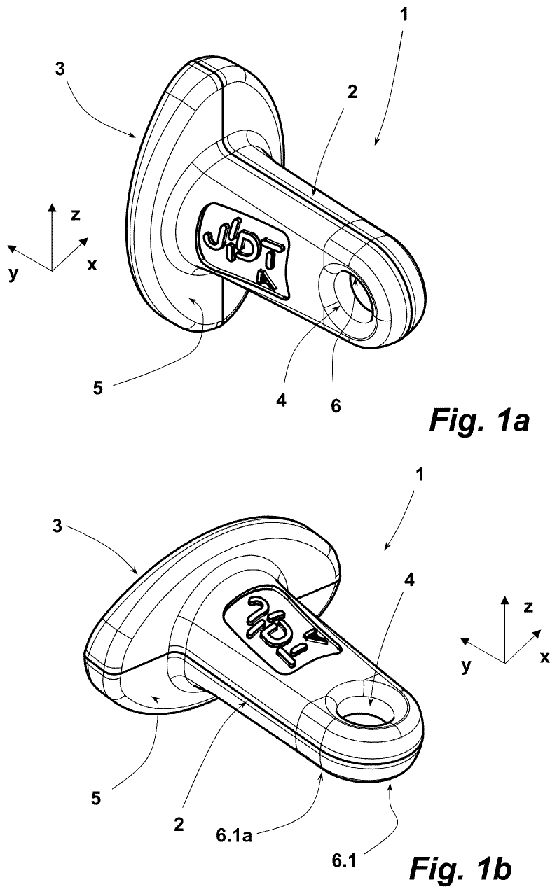

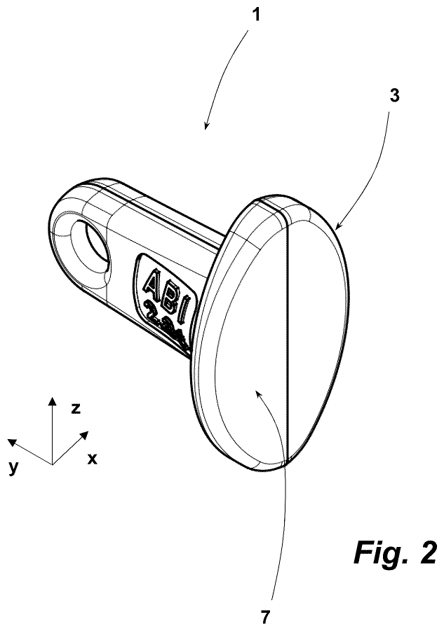

FIGS. 1a, 1b, and 2 show a lifting end piece 1 from different perspectives. A lifting end piece 1 comprises a pin 2 and a shield 3 formed thereon. At the end of the pin 2 opposite the shield 3, the pin 2 has an attachment point 4. The attachment point 4 is formed as an eye in the depicted embodiment. Lifting means, such as a chain or a chain link or a lifting belt for example, can be guided or hooked through the attachment point 4. Usually, the lifting means is permanently connected to the lifting end piece 1.

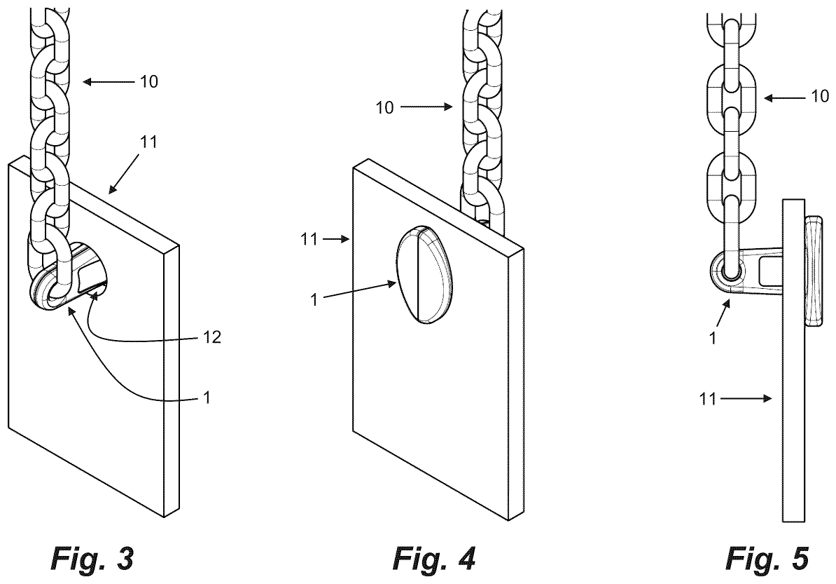

As seen in FIGS. 3-5, the lifting end piece 1 serves as a connecting piece between the lifting means 10 and an object 11 to be lifted. The object 11 has an opening 12 that is large enough for the lifting means 10 and the pin 2 to be passed therethrough. However, the opening 12 of the object 11 is usually smaller than the smallest diameter of the shield 3, which diameter extends in the x-direction in FIG. 1a. During the lifting of the object 11, the shield 3 abuts with its support surface 5 against the material surrounding the opening 12 of the object 11. A portion of the load to be lifted is also supported on the peripheral surface of the pin 2.

In the depicted embodiment, the shield 3 has an oval-shaped base with two semi-axes of different lengths. In FIG. 1a, the longer semi-axis (the major axis) points in the z-direction, and the shorter semi-axis (the minor axis) points in the x-direction.

Starting from the pin 2, the support surface 5 tapers towards its edge in the direction of the minor axis; the material thickness of the shield 3 decreases towards the edge in this direction. In the depicted embodiment, the taper is 7 degrees. In contrast, the shield 3 has a continuous thickness in the direction of the major axis, at least until the edge region. A rounding is provided towards the edge to avoid injuries and buckling.

If the lifting end piece 1 is aligned as shown in FIG. 1B (rotated by 90 degrees around the longitudinal axis of pin 2 with respect to FIG. 1a), the lifting end piece 1 will tilt during the lifting process in such a way that the lower part of the support surface 5 abuts against the material of the object 11 surrounding the opening 12 at the point of engagement 6.1; the upper part of the support surface 5 will be somewhat spaced from the material of the object 11 in this case. This tilting also tilts the pin 2 so that the attachment point 4 moves upwards in the z-direction.

The penetration direction of the attachment point 4 in the form of the eye is also in the direction of the taper, here in the direction of the minor axis (the x-direction in FIG. 1a). When the lifting end piece 1 is oriented as in FIG. 1a, the point of engagement 6 on the lifting end piece 1 is in the region of the eye pointing upwards. In the alignment of FIG. 1b, however, the point of engagement 6.1 is much lower, namely on the downward-pointing edge of the material of the pin 2 surrounding the eye. If the point of engagement is then in an off-center position, for example at 6.1a, a lever arm action is provided towards the longitudinal axis of pin 2, via which the lifting means 10 will turn the lifting end piece 1. Due to this circumstance, the orientation shown in FIG. 1b is fundamentally unstable during the lifting process, since the lifting end piece 1 will strive to rotate into the stable position according to FIG. 1a.

However, this effect is counteracted by the tapering of the shield 3 and its orientation: In the orientation of the lifting end piece 1 according to FIG. 1b, the pin 2 is slightly tilted under load, such that this tilting shifts the point of engagement of the lifting means 10 on the lifting end piece 1 with respect to the point of engagement 6.1a in the upward direction, so that the point of engagement is at the more stable point of engagement 6.1 than point of engagement 6.1a. In this way, both points of engagement 6, 6.1 can be described as stable under load (according to FIGS. 1a and 1b).

FIG. 2 shows the back side 7 of the shield 3 of the lifting end piece 1. The back side 7 is tapered complementarily to the support surface 5 of the lifting end piece 1. The complementary tapering ensures that the shield 3 is relatively thick in the direction of the major axis, such that a large moment of resistance against bending is provided. Such a large moment of resistance is not absolutely necessary in the direction of the minor axis, and therefore material can be saved by the complementary tapering in this case, which reduces weight.

The pin 2 of the lifting end piece 1 is designed like a chain link in the region of the attachment point 4 and has a cross-section which is wider (in the z-direction in FIG. 1a) than its thickness (in the x-direction in FIG. 1a). In this way, space is provided for a chain link engaging therein, wherein the chain link has the same or a smaller outer diameter than pin 2, so that the lifting end piece 1 together with the chain link can be passed through the opening 12 in the object 11.

Starting from the attachment point 4, the pin 2 is designed to increase in size along its longitudinal extent towards the shield 3. This causes a self-centering of the pin 2 in the opening 12 of the object 11 to be lifted. The increase in diameter of the pin 2 from the attachment point 4 towards the shield 3 takes place in the direction of the minor axis of the shield 3 to a larger extent than in the direction of the major axis. This enables a smooth transition from the pin 2 to the shield 3, which is particularly useful because of the tapering and thus thinning of the shield material in the direction of the minor axis of the shield 3.

The invention has been described on the basis of example embodiments. Without departing from the scope of the claims, those skilled in the art will recognize numerous further embodiments, modifications, permutations, additions, combinations and sub-combinations for implementing the inventive concept, without these having to be explained or shown in greater detail in the context of this disclosure. The claims should therefore be interpreted to include all such embodiments, modifications, permutations, additions and sub-combinations, which are within their true spirit and scope. Each embodiment described herein has numerous equivalents.

The terms and expressions which have been employed are used as terms of description and not of limitation, and there is no intention in the use of such terms and expressions of excluding any equivalents of the features shown or described, or portions thereof, but it is recognized that various modifications are possible within the scope of the invention. Thus, it should be understood that although the invention has been specifically disclosed by preferred embodiments and optional features, modification and variation of the concepts herein may be resorted to by those skilled in the art, and that such modifications and variations are considered to be within the scope of this invention as defined by the claims. Whenever a range is given in the specification, all intermediate ranges and subranges, as well as all individual values included in the ranges given are hereby incorporated into this disclosure. When a Markush group or other grouping is used herein, all individual members of the group and all combinations and sub-combinations possible of the group are hereby individually included in this disclosure. In general, the terms and phrases used herein have their art-recognized meaning, which can be found by reference to standard texts, references and contexts known to those skilled in the art. Any above definitions are provided to clarify their specific use in the context of the invention.

### LIST OF REFERENCE NUMERALS

1 lifting end piece
2 pin
3 shield
4 attachment point
5 support surface of the shield
6, 6.1, 6.1a point of engagement
7 back side of the shield
10 lifting means
11 object to be lifted
12 opening in object

1. An arrangement of an object to be lifted and a lifting end piece for connecting a lifting means to the object, the arrangement comprising:
the object, which comprises an opening, and
the lifting end piece, which comprises a pin and a shield,
wherein the pin is inserted through the opening of the object, and the pin has an attachment point on a free end thereof for connecting the lifting means,
wherein the shield is formed on another end of the pin opposite the attachment point, and the shield is aligned transversely to a longitudinal extension of the pin and projects outwardly from the pin,
wherein the shield and the attachment point are positioned on opposite sides of the opening of the object from one another,
wherein a base of the shield is larger than the opening of the object such that, when the lifting end piece is lifted at the attachment point, the shield supports material of the object surrounding the opening,
wherein a support surface of the shield, which faces toward the opening of the object, tapers starting from the pin toward an edge of the shield.

2. The arrangement of claim 1, wherein a back side of the shield, which is opposite the support surface and faces away from the pin, also tapers starting from a center thereof toward the edge of the shield.

3. The arrangement of claim 1, wherein the shield has an oval-shaped base with two semi-axes of unequal length corresponding to a major axis and a minor axis of the shield.

4. The arrangement of claim 3, wherein the shield has a greatest thickness along the major axis.

5. The arrangement of claim 3, wherein the pin increases in diameter from the attachment point towards the shield along the longitudinal extension of the pin, and the diameter of the pin increases to a lesser extent in a direction of the major axis of the shield than in a direction of the minor axis of the shield.

6. The arrangement of claim 3, wherein:
the shield tapers more along the minor axis than the major axis, and the shield has a greater thickness at distal ends of the major axis than at distal ends of the minor axis,
the pin increases in diameter from the attachment point towards the shield along the longitudinal extension of the pin, and the diameter of the pin increases to a lesser extent in a direction of the major axis of the shield than in a direction of the minor axis of the shield, and
the attachment point of the pin is designed as an eye, and a penetration direction of the eye through the pin is aligned in parallel to the minor axis of the shield.

7. The arrangement of claim 1, wherein the pin increases in diameter from the attachment point towards the shield along the longitudinal extension of the pin.

8. The arrangement of claim 7, wherein the diameter of the pin increases to a lesser extent in a direction of an axis of the shield than in a direction transverse to the axis of the shield.

9. The arrangement of claim 1, wherein the longitudinal extension of the pin is straight.

10. The arrangement of claim 1, wherein the lifting end piece is a forged part.

11. The arrangement of claim 1, further comprising the lifting means connected to the attachment point of the lifting end piece.

12. A lifting end piece for connecting a lifting means to an object having an opening, the lifting end piece comprising:
a pin having an attachment point on a free end thereof for connecting the lifting means, and
a shield formed on another end of the pin opposite the attachment point, the shield aligned transversely to a longitudinal extension of the pin and projecting outward from the pin,
wherein a base of the shield is configured to be larger than the opening in the object such that, when the pin is inserted through the opening of the object and the lifting end piece is lifted at the attachment point, the shield supports material of the object surrounding the opening,
wherein a support surface of the shield, which faces in a direction of the pin, tapers starting from the pin toward an edge of the shield.

13. The lifting end piece of claim 12, wherein a back side of the shield, which is opposite the support surface and faces away from the pin, also tapers starting from a center thereof toward the edge of the shield.

14. The lifting end piece of claim 12, wherein the shield has an oval-shaped base with two semi-axes of unequal length corresponding to a major axis and a minor axis of the shield.

15. The lifting end piece of claim 14, wherein the shield has a greatest thickness along the major axis.

16. The lifting end piece of claim 14, wherein the pin increases in diameter from the attachment point towards the shield along the longitudinal extension of the pin, and the diameter of the pin increases to a lesser extent in a direction of the major axis of the shield than in a direction of the minor axis of the shield.

17. The lifting end piece of claim 14, wherein:
the shield tapers more along the minor axis than the major axis, and the shield has a greater thickness at distal ends of the major axis than at distal ends of the minor axis,
the pin increases in diameter from the attachment point towards the shield along the longitudinal extension of the pin, and the diameter of the pin increases to a lesser extent in a direction of the major axis of the shield than in a direction of the minor axis of the shield, and
the attachment point of the pin is designed as an eye, and a penetration direction of the eye through the pin is aligned in parallel to the minor axis of the shield.

18. The lifting end piece of claim 12, wherein the pin increases in diameter from the attachment point towards the shield along the longitudinal extension of the pin.

19. The lifting end piece of claim 18, wherein the diameter of the pin increases to a lesser extent in a direction of an axis of the shield than in a direction transverse to the axis of the shield.

20. The lifting end piece of claim 12, wherein the longitudinal extension of the pin is straight.

21. The lifting end piece of claim 12, wherein the lifting end piece is a forged part.
